(19) United States
(12) Patent Application Publication
(10) Pub. No.: US 2010/0330843 A1
(43) Pub. Date: Dec. 30, 2010

(54) LAMP SOCKET POWER PLUG ADAPTER

(76) Inventors: HONG GAO, McKinney, TX (US); Jie Tan, McKinney, TX (US)

Correspondence Address: HONG GAO, 10212 BRENDEN DR, MCKINNEY, TX, 75070, US

(21) Appl. No.: 12/491,235

(22) Filed: Jun. 25, 2009

(51) Int. Cl. H01R 13/66

(52) U.S. Cl. 439/620.21

(57) ABSTRACT

A portable lamp socket power plug adapter connectable to a standard light bulb socket with electrical outlet functions for AC or DC plugs; The AC or DC electrical plug sockets provide any standard shape for the connection of plug to supply electrical appliances. The electrical plug sockets may function as USB sockets in providing DC power supply.

### BACKGROUND

The present application relates to power plug adapter, and more particularly to an adapter that fits in a lamp socket and provides power outlets or plug adaptations.

Note that the points discussed below may reflect the hindsight gained from the disclosed inventions, and are not necessarily admitted to be prior art.

Very often, in a work shop, in a laboratory, in a garage, in a factory, in a camp site, in a basement, in an attic of building, in a yard, in a sidewalk, in a parking lot, in a testing field, in a restaurant, in a classroom, in an office, in a hotel lobby, in a library, or at home, a power outlet built in the wall is found either too far away to be useful; or suitable ones have already been used, plugged-in with a lamp, a USB charger, a battery charger, a printer, a computer, etc.

Sometimes a wall outlet may be hidden in a difficult place and hard to reach, and more, for a household of having small children a built-in outlet as a source of an unsafe hazard can be blocked from access from children which also create inconvenience for adults. People may need to crawl under a table, move heavy furniture, twist in a small and narrow space to plug in their computers, PDAs or to recharge their cells phones.

But a lamp is usually located at a very handy and convenient place; access to a lamp socket does not require moving heavy furniture or crawling under a table. Lamps are often already in a plugged-in position, or are usually very conveniently built at the best place for human activities, and are already connected to the commercial Alternating Current (AC) power sources.

Further, mobile phones, PDAs, some computer peripherals are increasingly designed to use the USB sockets and one-hole jacks for Direct Current (DC) power supply connections.

### SUMMARY

To make use of the easy access of a lamp, the present application discloses new approaches and adapter designs for convenient access to the commercial AC power supply sources.

A portable lamp socket power plug adapter may be designed to screw or snatch into a standard lamp socket while at other ends provide AC or DC or both power outlets or plug adaptations for other electronic appliances.

In one embodiment, the lamp socket power plug adapter at one end contains a metallic screw threaded base for securely screwing or snatching into a lamp socket; while at the opposite end, contains a two-hole/three-hole standard power outlet socket to provide AC power supply for power plug. The metallic screw or snatch base is internally connected with the power plug socket, so that electricity can flow from the lamp socket through the base to the power plug socket of the adapter. The metallic screw base or snatch base may be made with any diameter sizes in accordance with the current standards or any popular lamp socket, it can be made to fit into a small reading lamp socket or it may be made to fit into a large lamp socket that is for high power lamps.

In one aspect of the embodiment, a lamp socket power plug adapter may have a circular or square, thick or thin, wide or narrow, 1 surface or multiple surfaces in use, or any other suitable sectional shape.

In another embodiment, a lamp socket power plug adapter may have an elongated body that contains multiple AC or DC or both power plug sockets.

In another embodiment, the metallic screw threaded base may be connected with the power plug socket end through a flexible and extensible power cable.

In another embodiment, a lamp socket power plug adapter contains a plurality of ends, at least one end forms a metallic screw threaded base or a snatch-on base, and also at least one end contains a lamp socket while other ends contain power plug sockets. The ends may be built in any angles with each other, or alternatively in right angle forming perpendicular intersections.

In another embodiment, a lamp socket power plug adapter contains at least one USB socket for DC power supply. The AC electricity from the lamp socket is converted into various specified DC voltages by an embedded internal voltage converter, so that various DC electrical appliances may directly plug into the socket without another power adapter. The AC electricity from the lamp socket can also be converted into various specified AC voltages by a buried internal voltage transformer, so that various AC electrical appliances may directly plug into the socket without another power adapter.

The disclosed innovations, in various embodiments, provide one or more of at least the following advantages. However, not all of these advantages result from every one of the innovations disclosed, and this list of advantages does not limit the various claimed inventions.

Portable and convenient;

Easy access;

Easy for AC and DC plug use.

### BRIEF DESCRIPTION OF THE DRAWINGS

The disclosed inventions will be described with reference to the accompanying drawings, which show important sample embodiments of the invention and which are incorporated in the specification hereof by reference, wherein:

FIG. 1A shows a perspective view of an example of an lamp socket power plug adapter in accordance with the disclosure.

FIG. 1B shows a top view of an example of a lamp socket power plug adapter in accordance with the disclosure.

FIGS. 2A, 2B, 3A, and 3B show the top views of different embodiments of a lamp socket power plug adapter in accordance with the disclosure.

FIG. 4 shows a perspective view of another embodiment of a lamp socket power plug adapter having multiple power plug sockets in accordance with the disclosure.

FIG. 5 shows a perspective view of another embodiment of a lamp socket power plug adapter having both a power plug socket and a lamp socket in accordance with the disclosure.

FIG. 6 shows a perspective view of another embodiment of a lamp socket power plug adapter having cabled USB power adapters in accordance with the disclosure.

FIG. 7 shows a perspective view of another embodiment of a lamp socket power plug adapter having cabled USB power adapters in accordance with the disclosure.

FIG. 8 shows a cross sectional view of an embodiment of a lamp socket power plug adapter having a standard power outlet and a USB power adapter in accordance with the disclosure.

### DETAILED DESCRIPTION OF SAMPLE EMBODIMENTS

The numerous innovative teachings of the present application will be described with particular reference to presently preferred embodiments (by way of example, and not of limitation). The present application describes several inventions, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

It is contemplated and intended that the design apply to both screw-thread based and snatch-up based lamp sockets; for clarity reason, the examples are given mostly based on the screw-thread based lamp socket, but an ordinary person in the art would know the variations to modify the design to be suitable for other types of lamp sockets.

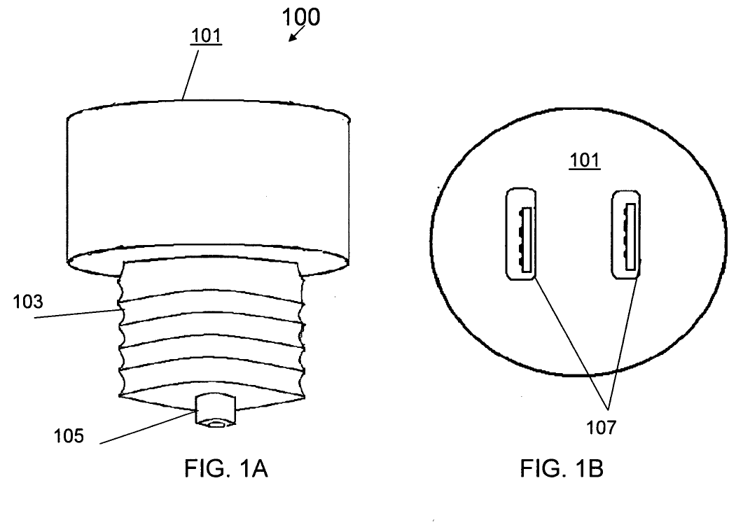

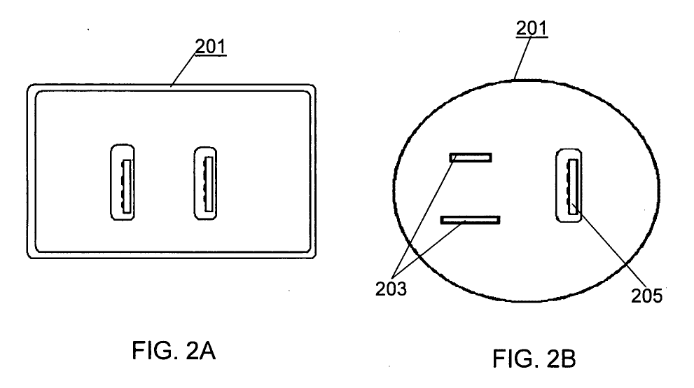

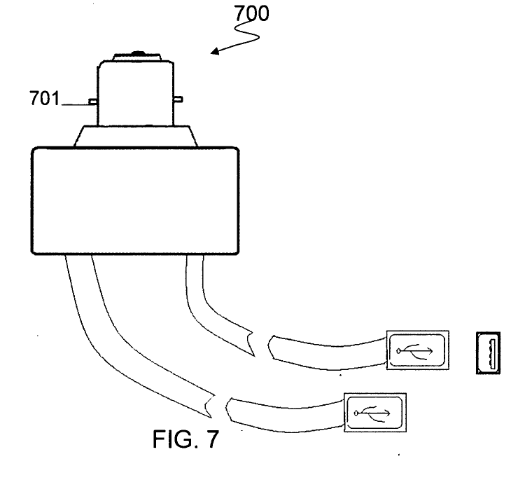

In reference to FIGS. 1A and 1B, a lamp socket power plug adapter 100 includes a body that has two adaptive ends, a lamp-base like end and a power plug socket end. End 103 is configured to include screw threads that match with a standard lamp socket, and can tightly screw into a lamp socket so that when connected electricity may flow from a lamp socket to the adapter. A metallic point 105 is located at the tip of the lamp-base end, which will be in contact with the hot line of a lamp socket, functioning similar to the metallic contact tip of a lamp base, as the hot line contact for the adapter. End 103 may also be designed to have a snap-on snatch for securing the adapter to a lamp socket (FIG. 7).

End 103 and tip 105 are covered on the surface with metal material, for example, aluminum or iron alloys, similar to a standard light bulb. End 103 and tip 105 are separated and insulated from each other to avoid electricity shortage.

Power plug socket end 101 contains power plug sockets. The configuration has at least two standard USB power outlets for holding two USB power plugs. FIG. 1B shows two USB power plug sockets.

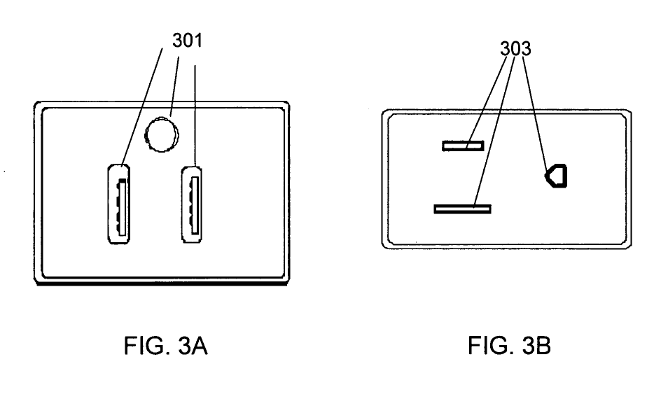

FIGS. 2A, 2B, 3A and 3B show alternative shapes of adapter 100. The cross section of the plug socket end may have rectangular 201, square 201, round 201 or any other suitable shapes, and the power outlet may be an one-hole socket 205, three-hole power socket 303, two-hole 203 or a combination of two hole power outlet 203 with a USB DC adapter 205. Sockets 203 contain metal contacts that are electrically connected respectively with the screw metal contact of 103 and the metal contact of tip 105.

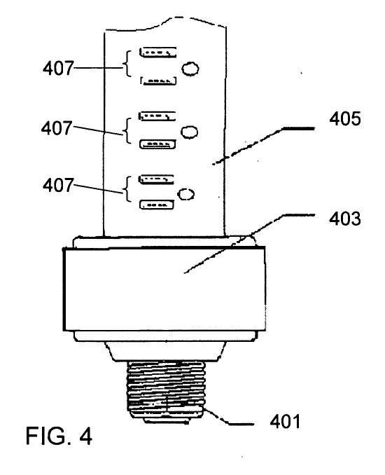

FIG. 4 shows another embodiment wherein the power plug socket end 405 may contain multiple power plug sockets 407. Lamp-screw base 401 is internally conductively connected with sockets 407. Body 403 is generally made of plastic material for safety and insulation. Sockets 407 may contain USB or one-hole DC or two-hole or three-hole AC sockets.

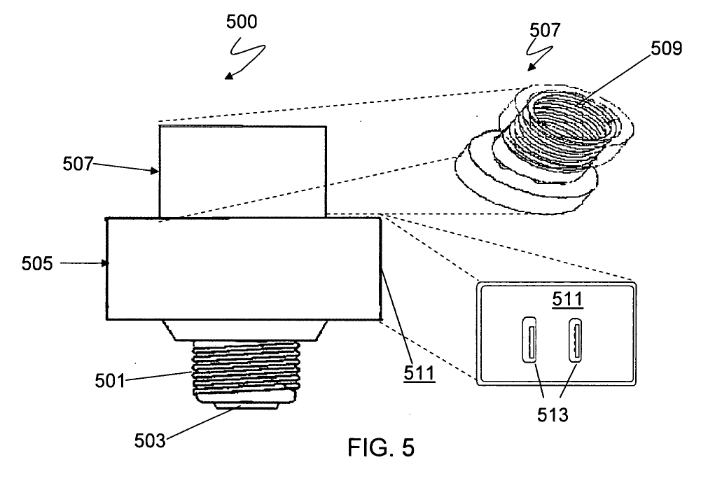

FIG. 5 shows another embodiment 500 which has a power plug 505 end as well as lamp socket end 507. Lamp socket 507 may be screw threaded or snatch-up style, suitable for securing standard lamps. may contain multiple power plug sockets 407. Power plug socket 505 may has its plug socket surface at the side of the adapter perpendicular to lamp socket 507. Light-bulb like base 501 and electrical contact 503 are located at one end to provide a fitting base and electrical contact with a standard lamp-socket. They are electrically connected with 505 and 507 for power supply. Alternatively, a voltage converter is enclosed in the body of 505 to convert standard 120 v into 220 v or 220 v into 120 v, or to convert the AC power source into DC supply. The DC output may vary depending a specific configuration, it may range from 3-20 volts for be suitable for computer power supplies, charging mobile phones, or PDA power uses.

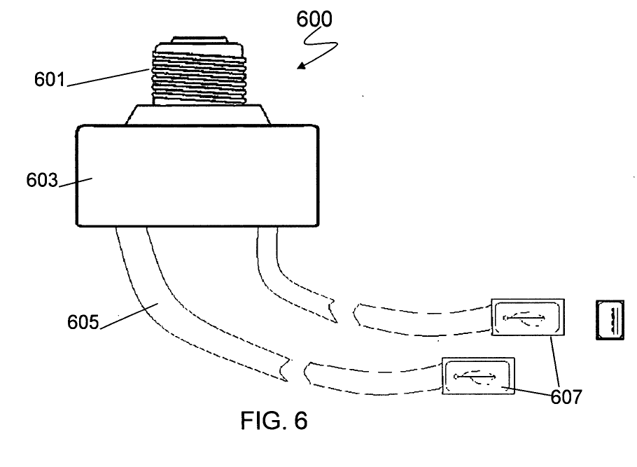

Alternatively, the power plug end may be extended with cable connections for flexibilities and distance usage as shown in FIGS. 6 and 7. Light-bulb base 601 or 701 (snatch style) provides the fitting base and electrical contact with a standard lamp-socket, while power plugs 607 provides power supply connections for other electronic appliances other than light bubs. Outlets 607 are connected through cables 605 to body 603 which may embed power converter chips to convert a commercial power supply into a suitable voltage and current for computer use, mobile phone and PDA power charge and for other electronic appliances.

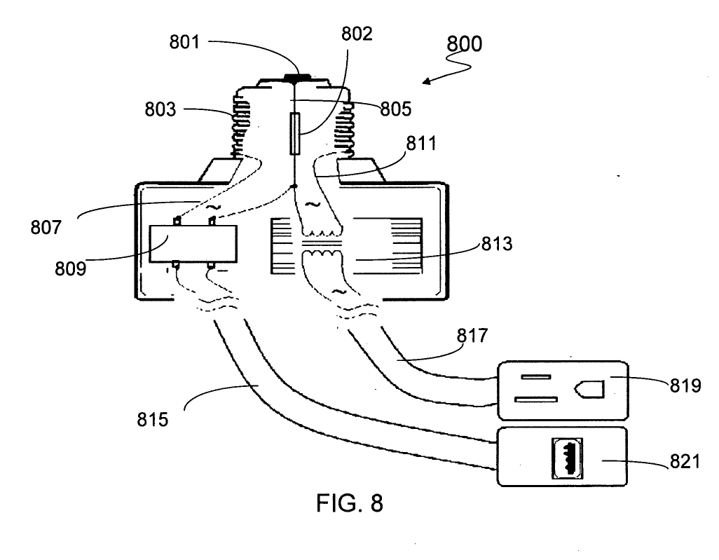

FIG. 8 illustratively demonstrates how a lamp socket power plug adapter may be configured. In embodiment 800, light-bulb base includes screw threaded support 803 and electric contact 801, which are insulated from each other and covered with metal for electric conduction from a lamp socket. Inside the body of adapter 800, contains an AC/DC converter 809 and a voltage transformer 813 which are electrically connected with 801 and 803 via electricity conductive lines 805 and 807. Line 805 is connected through a fuse for AC current and heat protections. Power outlets such as a USB DC outlet 821 and a standard AC power outlet 819 may be connected via cables 815 and 817.

Materials of adapter 800 may be any current standard hard plastics that are used for making power adapters. AC outlet 819 may be of any type power connectors, such as T or Y shape power connectors or the commonly used connectors for computer AC power plugs. DC outlet 821 may be of any type DC power connectors, such as USB or one-hole shape connectors or the commonly used connectors for computer DC power plugs.

According to various embodiments, there is provided: A lamp socket power plug adapter, comprising: a body having multiple sides; a light-bulb base plug that fits into a lamp socket; a converter that is electrically connected with said light-bulb base plug; and at least one standard power plug socket that is electrically connected with said converter; wherein said light-bulb base plug and said standard power plug socket are located at a respective side of the body, exposing their respective plug and socket, and said converter is embedded inside the body. According to various embodiments, there is provided: A lamp socket power plug adapter wherein said light bulb base plug is a standard Edison screw-in plug. wherein said light bulb base plug is a standard snatch-on bulb base plug, wherein said standard power plug socket is a one-hole socket, wherein said standard power plug socket is a two-hole or three-hole socket, wherein said standard power outlet socket is a USB socket, wherein said converter converts a AC commercial power supply from a lamp socket into DC power supply, wherein said converter converts an AC commercial power supply from a lamp socket into DC power supply in 1-21 voltage, wherein the adapter further comprising a fuse that protects from current overload or overheating.

According to various embodiments, there is provided: A lamp socket power plug adapter comprising: a body having multiple sides; a light-bulb base plug that fits into a lamp socket; a converter that is electrically connected with said light-bulb base plug; a transformer that is electrically connected with said light-bulb base plug; at least one first standard power plug socket that is electrically connected with said converter; and at least one second standard power plug socket that is electrically connected with said transformer; wherein said light-bulb base plug and said first and second standard power plug sockets are located at a respective side of the body, exposing their respective plug and sockets, and said converter and said transformer are embedded inside the body.

According to various embodiments, there is provided: A lamp socket power plug adapter a wherein said light bulb base plug is a standard Edison screw-in plug wherein said light bulb base plug is a standard snatch-on bulb base plug, wherein said first standard power plug socket is a DC socket and said second standard power plug socket is an AC socket wherein said first standard power plug socket is a USB socket wherein said converter converts an AC commercial power supply from a lamp socket into DC power supply in 1-21 voltage, the adapter further comprising a fuse that protects from current overload or overheating wherein said transformer transforms an AC commercial power supply from a lamp socket into a different voltage AC power.

According to various embodiments, there is provided: A lamp socket power plug adapter comprising body having multiple sides; a light-bulb base plug that fits into a lamp socket; a converting unit that is electrically connected with said light-bulb base plug; at least one first standard power plug socket that is electrically connected with said converting unit; and wherein said light-bulb base plug is located at one side of the body, exposing the plug, said converter and said transformer are embedded inside the body, and said standard power plug socket is connected to said converting unit through an extended wire and is located at terminal of the wire, wherein said converting unit is an AC/DC converter wherein said converting unit is an AC voltage transformer.

### Modifications and Variations

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

The electrical contacts may be steel or brass, and may be plated with zinc, tin, or nickel in the power plug sockets and on the light bulb screw-base. The power plug sockets may be designed to comply with any industrial standards, such as to match with type A, B, C, D, E, F, H, J, K, L, or M plugs.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A lamp socket power plug adapter, comprising:
a body having multiple sides;
a light-bulb base plug that fits into a lamp socket;
a converter that is electrically connected with said light-bulb base plug; and
at least one standard power plug socket that is electrically connected with said converter;
wherein said light-bulb base plug and said standard power plug socket are located at a respective side of the body, exposing their respective plug and socket, and said converter is embedded inside the body.

2. The adapter of claim 1, wherein said light bulb base plug is a standard Edison screw-in plug.

3. The adapter of claim 1, wherein said light bulb base plug is a standard snatch-on bulb base plug.

4. The adapter of claim 1, wherein said standard power plug socket is a one-hole socket.

5. The adapter of claim 1, wherein said standard power plug socket is a two-hole or three-hole socket.

6. The adapter of claim 1, wherein said standard power outlet socket is a USB socket.

7. The adapter of claim 1, wherein said converter converts a AC commercial power supply from a lamp socket into DC power supply.

8. The adapter of claim 1, wherein said converter converts an AC commercial power supply from a lamp socket into DC power supply in 1-21 voltage.

9. The adapter of claim 1, further comprising a fuse that protects from current overload or overheating.

10. A lamp socket power plug adapter, comprising:
a body having multiple sides;
a light-bulb base plug that fits into a lamp socket;
a converter that is electrically connected with said light-bulb base plug;
a transformer that is electrically connected with said light-bulb base plug;
at least one first standard power plug socket that is electrically connected with said converter; and
at least one second standard power plug socket that is electrically connected with said transformer;
wherein said light-bulb base plug and said first and second standard power plug sockets are located at a respective side of the body, exposing their respective plug and sockets, and said converter and said transformer are embedded inside the body.

11. The adapter of claim 10, wherein said light bulb base plug is a standard Edison screw-in plug.

12. The adapter of claim 10, wherein said light bulb base plug is a standard snatch-on bulb base plug.

13. The adapter of claim 10, wherein said first standard power plug socket is a DC socket and said second standard power plug socket is an AC socket.

14. The adapter of claim 10, wherein said first standard power plug socket is a USB socket.

15. The adapter of claim 10, wherein said converter converts an AC commercial power supply from a lamp socket into DC power supply in 1-21 voltage.

16. The adapter of claim 10, further comprising a fuse that protects from current overload or overheating.

17. The adapter of claim 10, wherein said transformer transforms an AC commercial power supply from a lamp socket into a different voltage AC power.

18. A lamp socket power plug adapter, comprising:
a body having multiple sides;
a light-bulb base plug that fits into a lamp socket;
a converting unit that is electrically connected with said light-bulb base plug;
at least one first standard power plug socket that is electrically connected with said converting unit; and
wherein said light-bulb base plug is located at one side of the body, exposing the plug, said converter and said transformer are embedded inside the body, and said standard power plug socket is connected to said converting unit through an extended wire and is located at terminal of the wire.

19. The adapter of claim 18, wherein said converting unit is an AC/DC converter.

20. The adapter of claim 18, wherein said converting unit is an AC voltage transformer.
